(19) United States
(12) Patent Application Publication
(10) Pub. No.: US 2026/0169453 A1
(43) Pub. Date: Jun. 18, 2026

(54) SPATIAL-STATE PREDICTION METHOD AND SPATIAL-STATE PREDICTION SYSTEM

(71) Applicant: Panasonic Intellectual Property Management Co., Ltd., Osaka (JP)

(72) Inventors: YOKO KASAI, Osaka (JP); YUKI ARAI, Osaka (JP); TAKAYA MATSUMOTO, Osaka (JP); KEIKO TAKAHASHI, Osaka (JP); JUNICHI WATANABE, Osaka (JP)

(21) Appl. No.: 19/534,850

(22) Filed: Feb. 10, 2026

Related U.S. Application Data
(63) Continuation of application No. PCT/JP2024/040491, filed on Nov. 14, 2024.

(30) Foreign Application Priority Data
Dec. 18, 2023 (JP) 2023-213134

(51) Int. Cl. G05B 19/042

(52) U.S. Cl. CPC G05B 19/042; G05B 2219/21

(57) ABSTRACT

A spatial-state prediction method is a method for predicting a state quantity in space (10) by performing data assimilation processing using a measurement value of sensor (200) that detects a state quantity in space (10), and includes: a step of acquiring a measurement value of sensor (200) arranged at a predetermined position in space (10); and a step of moving sensor (200) when a variation of the measurement value of sensor (200) from first time (t1) to second time (t2) is equal to or less than predetermined first management value (V1).

### TECHNICAL FIELD

The present disclosure relates to a spatial-state prediction method for predicting a state quantity of a space in a building, and a spatial-state prediction system thereof.

### BACKGROUND ART

Conventionally, an air-conditioning control system that predicts a state quantity such as a temperature or a thermal load of a building in a space in a building provided with equipment such as an air-conditioning device is known. PTL 1 discloses an air-conditioning control system that predicts a thermal load of a building. In this air-conditioning control system, a fixed sensor that senses temperature, humidity, CO₂ concentration, or the like is fixedly installed indoors or outdoors.

### CITATION LIST

### Patent Literature

PTL 1: Japanese Patent No. 5951120

### SUMMARY OF THE INVENTION

In the air-conditioning control system disclosed in PTL 1, for example, when air flow, temperature, or the like in a space fluctuates temporally or spatially due to an operational condition of an air-conditioning device, opening/closing of a window, a door, or the like, weather, movement of a person, or the like, these variations may not be measured depending on an installation position of a fixed sensor. Therefore, when the state quantity in the space is predicted using this fixed sensor, there is a problem that the prediction accuracy of the state quantity in the space decreases.

The present disclosure solves the above problem, and provides a spatial-state prediction method and the like capable of suppressing a decrease in prediction accuracy of a state quantity in a space.

A spatial-state prediction method according to one aspect of the present disclosure is a spatial-state prediction method for predicting a state quantity in a space by performing data assimilation processing using a measurement value of a sensor that detects the state quantity in the space, the method including a step of acquiring a measurement value of the sensor disposed at a predetermined position in the space, and a step of moving the sensor when a variation of the measurement value of the sensor from a first time to a second time is equal to or less than a predetermined first management value.

A spatial-state prediction system according to one aspect of the present disclosure is a spatial-state prediction system that performs data assimilation processing using a measurement value of a sensor that detects a state quantity in a space and predicts the state quantity in the space, the spatial-state prediction system including an information acquisition unit that acquires a measurement value of the sensor arranged at a predetermined position in the space, and a controller that outputs a movement signal for moving the sensor when a variation of the measurement value of the sensor from a first time to a second time is equal to or less than a predetermined first management value.

General or specific aspects of the present disclosure may be achieved by a system, a method, an integrated circuit, a computer program, or a recording medium such as a computer-readable compact disc read-only memory (CD-ROM), or may be achieved by any combination of the system, the method, the integrated circuit, the computer program, and the recording medium.

According to the spatial-state prediction method and the like of the present disclosure, it is possible to suppress a decrease in prediction accuracy of the state quantity in the space.

### BRIEF DESCRIPTION OF THE DRAWINGS

FIG. 1 is a block diagram illustrating a basic configuration of a spatial-state prediction system.

FIG. 2 is a diagram illustrating an example of a space in a building.

FIG. 3 is a diagram illustrating a computer constituting a spatial-state prediction device included in a spatial-state prediction system.

FIG. 4 is a block diagram illustrating a configuration of a spatial-state prediction system according to an example.

FIG. 5 is a diagram illustrating an example of a sensor mobile body arranged in a space.

FIG. 6 is a diagram illustrating an example of a space in a building to which prediction by the spatial-state prediction system according to the example is applied.

FIG. 7 is a diagram illustrating an example of a change in a state quantity in a space.

FIG. 8 is a diagram illustrating a change in a measurement value of a sensor arranged in a space.

FIG. 9 is a flowchart illustrating a spatial-state prediction method according to an example.

FIG. 10 is a flowchart illustrating a spatial-state prediction method of Modification 1.

FIG. 11 is a flowchart illustrating a spatial-state prediction method of Modification 2.

FIG. 12 is a flowchart illustrating a spatial-state prediction method of Modification 3.

### DESCRIPTION OF EMBODIMENT

An exemplary embodiment and the like will be described hereinafter with reference to the drawings. The exemplary embodiment and the like described hereinafter provide general or specific examples. Numerical values, shapes, materials, constituent elements, arrangement positions and connection modes of the constituent elements, steps, order of the steps, and the like described in the following exemplary embodiment and the like are merely examples, and not intended to limit the present disclosure. In addition, among the constituent elements in the following exemplary embodiment and the like, constituent elements not described in the independent claims will be described as optional constituent elements.

Each drawing is schematically illustrated and thus is not strictly accurate. In addition, in the drawings, substantially the same constituent elements will be denoted by the same reference signs, and redundant description thereof is omitted or simplified. In addition, even when the same object is illustrated in the drawings, a scale may be changed for the sake of convenience.

### [Basic Configuration of Spatial-State Prediction System]

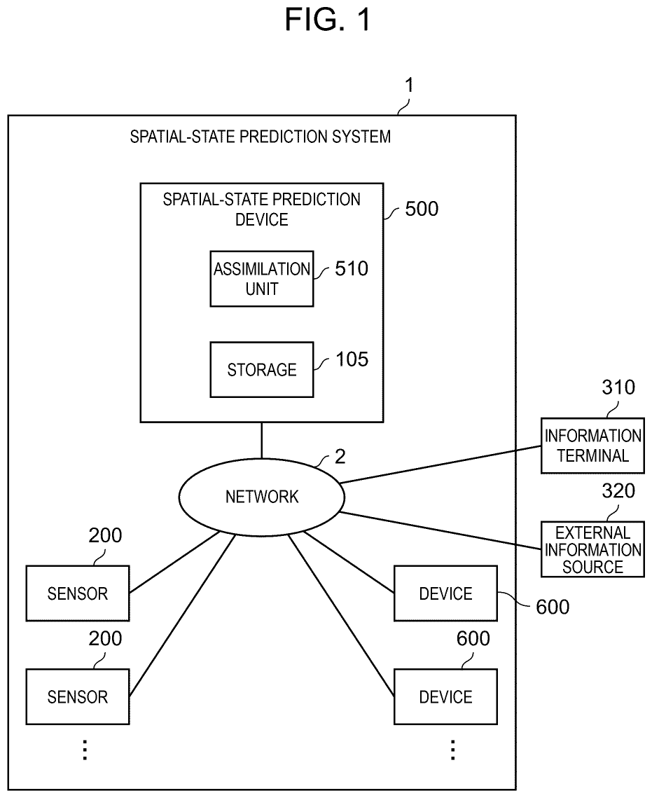

FIG. 1 is a block diagram illustrating a basic configuration of a spatial-state prediction system.

The spatial-state prediction system is a system that predicts a state quantity of a space in a building. A space to be predicted is, for example, a space partitioned by walls in a building such as a house, an office, a store, a public facility, an entertainment facility, a gallery, a museum, a factory, or a warehouse. A state quantity of a space is a physical quantity indicating a state of the space, and is, for example, a temperature distribution, a humidity distribution, a wind speed (including wind direction) distribution, a gas concentration distribution, and a PM2.5 (microparticulate matter) distribution of the space. Spatial-state prediction system 1 includes spatial-state prediction device 500, one or more sensors 200 capable of communicating via network 2, and device 600.

Each sensor 200 is a device that detects a state quantity and a boundary condition at a predetermined position in a building. The state quantity at the predetermined position is, for example, a temperature, humidity, wind speed, gas concentration, and the amount of PM2.5 at the predetermined position. The boundary condition at the predetermined position is an external environment that affects the state quantity of the space or a physical quantity indicating a state of a boundary region between the space and the outside. Examples of the external environment that affects the state quantity of the space include the outside air temperature, the outside wall temperature, the outside air humidity, the outside wind speed, the outside gas concentration, the amount of the outside PM2.5, and the amount of solar radiation. The state of the boundary region between the space and the outside is, for example, opening area (or an opening angle) of a door or a window provided in the building. Sensor 200 is, for example, a thermometer, a hygrometer, an anemometer, a gas concentration meter, a PM2.5 measuring device, a pyranometer, a door sensor, or a window sensor, and is provided inside the space, outside the space, or in a boundary region between the space and the outside. Sensor 200 is attached to a mobile device such as a self-propelled robot or a drone. Configurations of sensor 200 and the mobile device will be described later.

Detection information detected by sensor 200 is transmitted to spatial-state prediction device 500 over network 2. When sensor 200 is an image sensor, information regarding the position of a person in the space may be transmitted to spatial-state prediction device 500.

Devices 600 are devices that form an environment of the space in a building, and include, for example, an air-conditioning device, a ventilator, an air purifier, a circulator, or a gas diffusion device. Devices 600 are provided in the space of a building or in a boundary region between the space and the outside. In addition, each device 600 transmits operational information including current operational conditions and an operational history to spatial-state prediction device 500. The operational conditions of each device 600 include physical quantities such as a temperature, humidity, an air volume, and a wind direction of air delivered from device 600. When one of devices 600 is an air-conditioning device, the operational information may include information regarding a set temperature of air, a blown air volume, a sucked air volume, a rotation speed of a fan, and the amount of power supplied to a heat exchanger. When one of devices 600 is a gas diffusion device that releases a diffusing substance such as hypochlorous acid, a sterilizing ion, or a fragrance, information regarding a released gas concentration, a release amount, and a release direction of the diffusing substance may be included in the operational information.

Furthermore, spatial-state prediction device 500 is communicably connected to information terminal 310 and external information source 320 via network 2.

Information terminal 310 is a terminal device owned and carried by the user, and may be, for example, a smart device such as a smartphone, a tablet terminal, and a wearable terminal, and a portable terminal having portability such as a personal computer. Information terminal 310 may be used to receive information regarding the prediction system held by spatial-state prediction device 500 via network 2 and notify the user of the information.

External information source 320 is Internet of Things (IoT) data existing on the Internet. For example, the IoT data includes weather data.

Spatial-state prediction device 500 is provided in computer 100 described later. Note that spatial-state prediction device 500 may be provided in a computer on a cloud. Spatial-state prediction device 500 includes assimilation unit 510 that performs data assimilation processing and storage 105 that stores various types of information for performing simulation.

In assimilation unit 510, the detection information detected by sensor 200 and the simulation model (prediction model) are integrated, and appropriate initial values, boundary values, and parameters are determined so as to reproduce the phenomenon. In storage 105, space layout information is stored in advance. The layout information includes information regarding a shape and size of the space, and information regarding objects arranged in the space such as desks and partitions, and positions of the objects. The information of the space shape is, for example, data obtained by 3D modeling the space to be analyzed and then converting a resultant 3D model into a point cloud by a finite volume method.

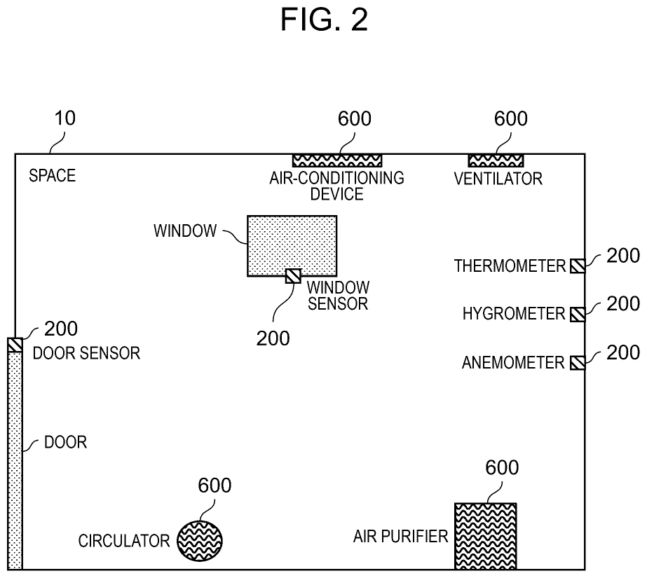

FIG. 2 is a diagram illustrating an example of space 10 in a building.

FIG. 2 is a top view of space 10. An example is illustrated in which a thermometer, a hygrometer, and an anemometer are provided as sensor 200 that detects the state quantity in space 10, and an air-conditioning device, a circulator, a ventilator, and an air purifier are provided as device 600 that forms the environment of space 10. In the drawing, as sensor 200 that detects the boundary condition, a door sensor that detects an open/close state of a door and a window sensor that detects an open/close state of a window are illustrated. Each of the door sensor and the window sensor can detect not only presence or absence of opening/closing but also an opening/closing amount. In this drawing, illustration of the gas concentration meter and the gas diffusion device is omitted. The detection information detected by sensor 200 and the operational information of device 600 are transmitted to spatial-state prediction device 500 via network 2.

Spatial-state prediction device 500 performs simulation of space 10 based on various types of information stored in storage 105, detection information acquired from sensor 200, IoT data acquired from external information source 320, and the like, and predicts a state quantity of space 10.

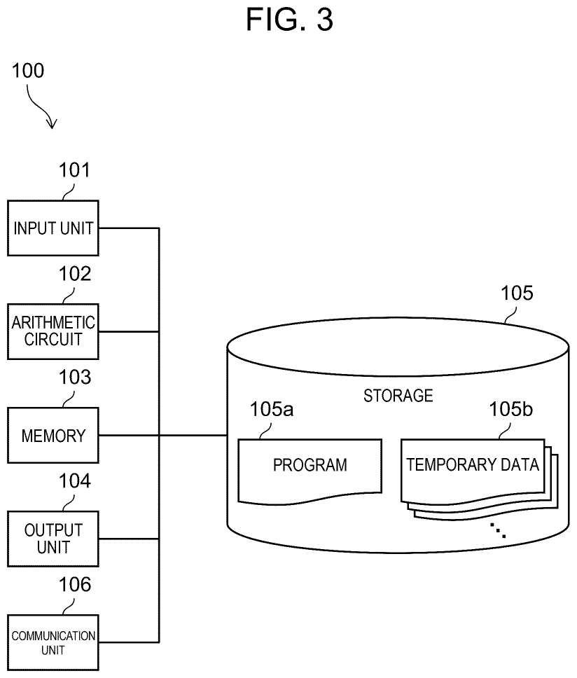

FIG. 3 is a diagram illustrating computer 100 constituting spatial-state prediction device 500 included in spatial-state prediction system 1.

Computer 100 includes input unit 101, arithmetic circuit 102, memory 103, output unit 104, storage 105, and communication unit 106.

Communication unit 106 communicates with sensor 200, device 600, information terminal 310, and external information source 320 via network 2 in a wireless or wired manner. The wireless communication method may be Wi-Fi (registered trademark), Bluetooth (registered trademark), or ZigBee (registered trademark), or may be other methods.

Input unit 101 has a function as a human machine interface (HMI) that receives an input operation by a user, and includes, for example, a keyboard, a mouse, a touch sensor, a touch pad, and the like. A part of the layout information of space 10 may be input to computer 100 via input unit 101.

Output unit 104 includes a display that displays an image, characters, or the like, and the display is, for example, a liquid crystal display, a plasma display, an organic electro-luminescence (EL) display, or the like. Note that, output unit 104 may include a printer that prints an image, characters, or the like, and may have a function of storing data output from arithmetic circuit 102 in storage 105 in a file format.

Storage 105 stores program (that is, computer program) 105a in which each command to arithmetic circuit 102 is described. Program 105a is stored in storage 105 via, for example, a removable medium or network 2. The removable medium is, for example, a compact disc read only memory (CD-ROM), a flash memory, or the like. Thus, communication unit 106 may include an interface that reads program 105a of the removable medium.

In addition, simulation software for performing numerical analysis is stored in storage 105. Examples of the simulation software include Computational Fluid Dynamics (CFD) and Building Information Modeling (BIM).

In addition, each temporary data 105b temporarily generated by processing of arithmetic circuit 102 is stored in storage 105. Such storage 105 is a non-volatile recording medium, and is, for example, a magnetic storage device such as a hard disk, an optical disk, a semiconductor memory, or the like. In the present exemplary embodiment, layout information and simulation information of space 10 are stored in storage 105. In addition, storage 105 stores information such as a boundary condition, a state quantity of space 10, and an operational condition of the device in the process of calculation.

Program 105a read and loaded by arithmetic circuit 102 is temporarily stored in memory 103. Such memory 103 is, for example, a volatile random access memory (RAM).

Arithmetic circuit 102 is a circuit that executes program 105a loaded in memory 103, and is, for example, a central processing unit (CPU), a graphics processing unit (GPU), or the like. Arithmetic circuit 102 may use each temporary data 105b stored in storage 105 when program 105a is executed.

Arithmetic circuit 102 is a circuit for realizing the function of spatial-state prediction device 500. Arithmetic circuit 102 performs simulation of space 10 using simulation software and predicts a state quantity of space 10.

### [Spatial-State Prediction System According to Example]

Spatial-state prediction system 1A according to an example as an example of the above-described spatial-state prediction system 1 will be described.

Spatial-state prediction system 1A is a system that predicts a state quantity in space 10 by performing data assimilation processing using a measurement value of sensor 200 that detects a state quantity in space 10.

The state of space 10 in the building changes depending on, for example, an operational condition of an air-conditioning device provided in space 10, opening and closing of a window, a door, or the like, a surrounding environment such as weather, movement of a person, or the like, and along with the change, a gas concentration, an air flow, a temperature, or the like, which is a state quantity of space 10, also changes. Therefore, the current position of sensor 200 arranged in space 10 may be an inappropriate position as a measurement position for predicting the state quantity of space 10. In this case, the prediction accuracy of the state quantity of space 10 obtained by the data assimilation processing decreases. In this example, in order to suppress a decrease in the prediction accuracy of the state quantity of space 10, sensor 200 can be moved to an appropriate position.

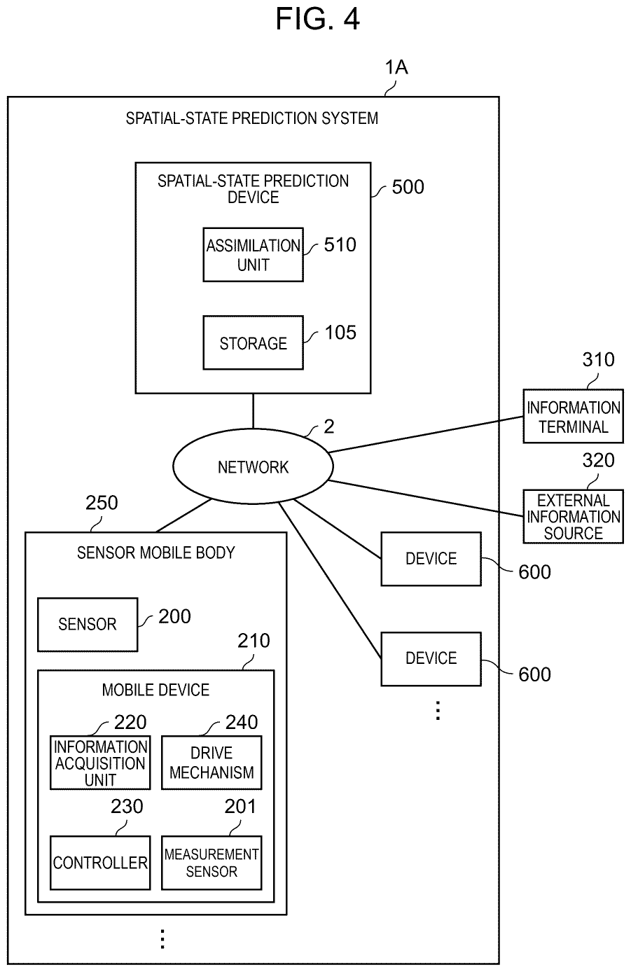

FIG. 4 is a block diagram illustrating a configuration of spatial-state prediction system 1A according to the example.

Spatial-state prediction system 1A according to the example includes spatial-state prediction device 500, sensor mobile body 250, device 600, and the like. The configurations of spatial-state prediction device 500 and device 600 are similar to those of the exemplary embodiment illustrated in FIG. 1.

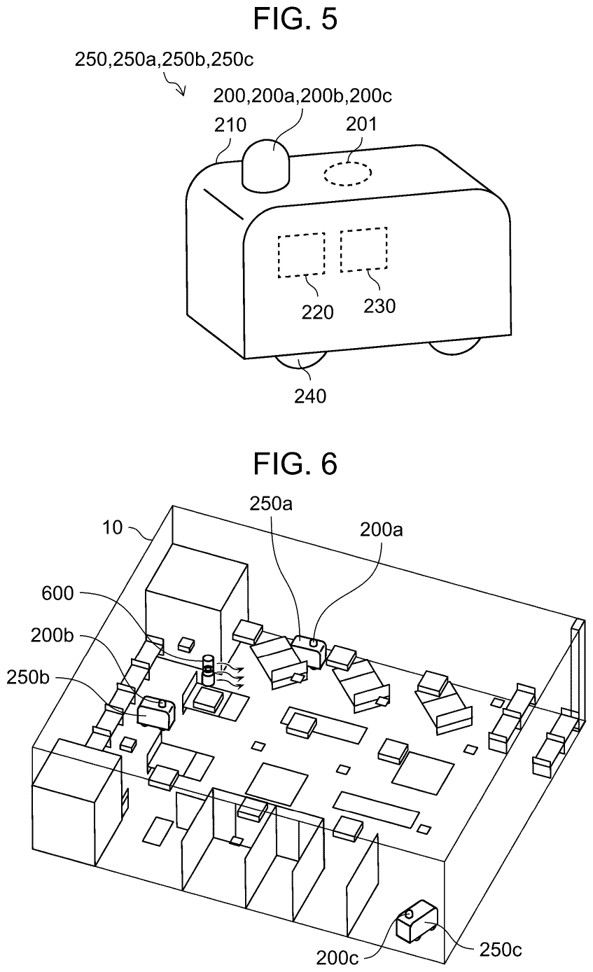

FIG. 5 is a diagram illustrating an example of sensor mobile body 250 arranged in space 10.

As illustrated in the drawing, sensor mobile body 250 includes sensor 200 and mobile device 210 to which sensor 200 is attached.

Sensor 200 is at least one of a thermometer, a hygrometer, an anemometer, a gas concentration meter, a PM2.5 measuring instrument, and a solar radiation meter. Sensor 200 measures the state quantity in space 10, and measurement data measured by sensor 200 is output to mobile device 210.

Mobile device 210 is a device for mobile sensor 200. Mobile device 210 is, for example, a self-propelled robot or a drone that freely moves around in space 10. Note that mobile device 210 may be a mobile robot that moves along a rail laid in space 10. Mobile device 210 according to the present example also determines whether to move sensor 200.

Mobile device 210 includes information acquisition unit 220, controller 230, drive mechanism 240, and positioning sensor 201.

Drive mechanism 240 includes a plurality of components for moving sensor mobile body 250, and includes, for example, components such as a motor, a gear, and a wheel.

Controller 230 controls operations of sensor 200, positioning sensor 201, information acquisition unit 220, and drive mechanism 240. Controller 230 has a communication function for communicating with spatial-state prediction device 500.

Information acquisition unit 220 acquires information regarding the measurement value of sensor 200 output from sensor 200. Information regarding the measurement value of sensor 200 is transmitted to spatial-state prediction device 500 via controller 230.

Positioning sensor 201 has a global positioning system (GPS) function for acquiring its own position information. Positioning sensor 201 may include a gyro sensor and an acceleration sensor. The position information of sensor 200 obtained by positioning sensor 201 is transmitted to spatial-state prediction device 500 via controller 230.

FIG. 6 is a diagram illustrating an example of space 10 in a building to which prediction by spatial-state prediction system 1A according to the example is applied.

The drawing illustrates an example in which space 10 is an office space. In addition, the drawing illustrates an example in which device 600 disposed in space 10 is a gas diffusion device that releases a predetermined diffusing substance, and sensors 200a, 200b, 200c mounted corresponding to sensor mobile bodies 250, 250b, 250c are gas concentration meters that detect the gas concentration of the predetermined diffusing substance. Hereinafter, all or any one of sensor mobile bodies 250a, 250b, and 250c may be referred to as sensor mobile body 250, and all or any one of sensors 200a, 200b, 200c may be referred to as sensor 200.

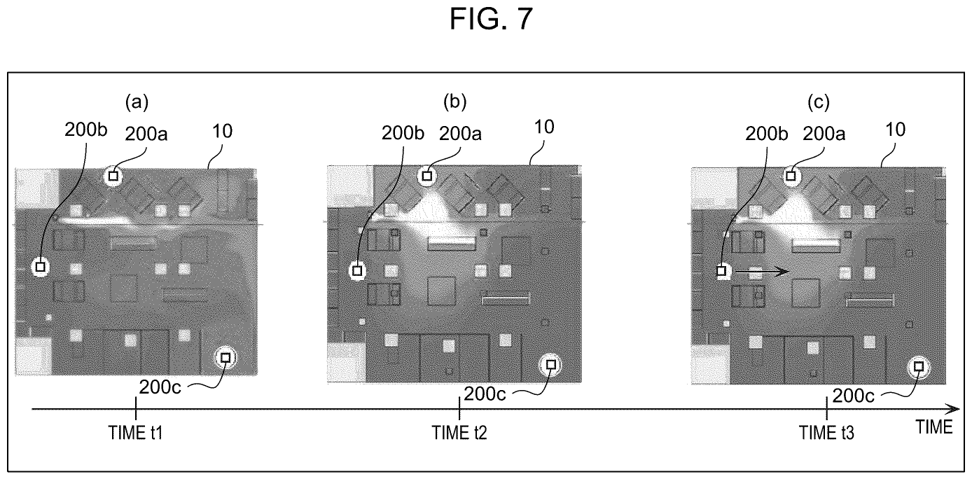

FIG. 7 is a diagram illustrating an example of a change in a state quantity in space 10.

This drawing illustrates a gas concentration distribution of a predetermined diffusing substance when space 10 is viewed from above, and it is illustrated that the closer to black, the lower the gas concentration, and the closer to white, the higher the gas concentration. In this example, the diffusing substance is released from the right side of device 600, and the gas concentration in the region on the right side of device 600 is high. (a), (b), and (c) of FIG. 7 illustrate gas concentration distributions at first time t1, second time t2, and third time t3, respectively. Second time t2 is a time 30 minutes after first time t1, and third time t3 is a time further after second time t2. The state quantity such as the gas concentration varies as the situation in space 10 changes.

In this example, in order to measure the state quantity of space 10 at an appropriate position according to the change in the situation in space 10, the sensor having a small variation of the measurement value is moved to a position different from the current position. In the example illustrated in FIG. 7, the positions of three sensors 200a to 200c are fixed in the period from first time t1 to second time t2, but sensor 200b moves in the arrow direction at third time t3.

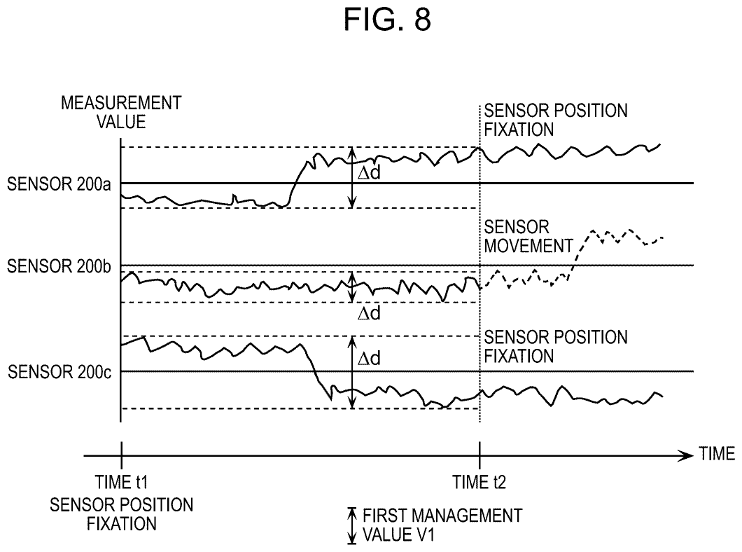

FIG. 8 is a diagram illustrating changes in measurement values of sensors 200a, 200b, 200c disposed in space 10.

Each of sensors 200a to 200c is first disposed at a predetermined position in space 10, and measures a state quantity in space 10 at a predetermined sampling period. The predetermined position is a fixed position specified in space 10. Note that the fixed position does not mean fixed to a wall or a floor, but means fixed as position coordinates. The sampling period is, for example, 1/10 or less of the periods of first time t1 and second time t2. In this example, the variation of the measurement values of sensors 200a, 200c is relatively large from first time t1 to second time t2, but the variation of the measurement value of sensor 200b is relatively small.

Sensor mobile body 250 of the present exemplary embodiment autonomously moves in space 10 when it is necessary to change the position of sensor 200, and arranges sensor 200 mounted thereon at an appropriate position.

In order to determine whether it is necessary to change the position of sensor 200, information acquisition unit 220 of sensor mobile body 250 acquires a measurement value of sensor 200 from first time t1 to second time t2. Controller 230 determines whether the variation of the measurement value of sensor 200 from first time t1 to second time t2 is equal to or less than a predetermined first management value V1. The management value is a value serving as a criterion for determining whether a certain value applies to a specific event. When the variation of the measurement value of sensor 200 is equal to or less than first management value V1, controller 230 outputs a movement signal for moving sensor 200 to drive mechanism 240. Drive mechanism 240 is driven based on a movement signal output from controller 230 to move sensor 200.

For example, sensor mobile body 250 moves sensor 200 when the difference between the maximum value and the minimum value of the measurement value of sensor 200 is equal to or less than first management value V1. In sensors 200a and 200c illustrated in FIG. 8, since difference Δd between the maximum value and the minimum value of the measurement value is not equal to or less than first management value V1, the positions of sensors 200a and 200b remain fixed even after second time t2. On the other hand, since difference Δd between the maximum value and the minimum value of the measurement value is equal to or less than first management value V1, sensor 200b is moved to another position after second time t2.

For example, sensor mobile body 250 may autonomously move by a random movement like a cleaning robot. Furthermore, sensor mobile body 250 may move by determining a movement range or a movement route based on a learning result obtained by machine learning based on a past movement history. Furthermore, in sensor mobile body 250, a movement permitted area in space 10 may be set in advance such that the plurality of sensor mobile bodies 250 do not simultaneously exist in the same area.

Note that the example in which sensor 200 is moved when the difference between the maximum value and the minimum value of the measurement value of sensor 200 is equal to or less than first management value V1 has been described above, but the present disclosure is not limited thereto.

For example, sensor mobile body 250 may move sensor 200 when a difference between the measurement value at first time t1 and the measurement value at second time t2 is equal to or less than a predetermined difference. In other words, sensor mobile body 250 may move sensor 200 when the change gradient of the measurement value from first time t1 to second time t2 is equal to or less than first management value V1 (predetermined management value). Note that the numerical value of first management value V1 in this case is a numerical value related to the change gradient, unlike the numerical value of first management value V1 for determining the magnitude of the difference between the maximum value and the minimum value of the measurement value.

In addition, sensor mobile body 250 obtains the variation range of the front-rear section while taking the moving average from first time t1 to second time t2, and may move sensor 200 when the variation range is first management value V1 or less.

Spatial-state prediction device 500 performs the data assimilation processing using the measurement values of sensors 200a and 200c without using the measurement value of sensor 200b that is moving. Note that spatial-state prediction device 500 may perform the data assimilation processing using the measurement value of sensor 200b that is moving and the measurement values of sensors 200a, 200c whose positions are fixed.

Sensor mobile body 250 fixes the position of sensor 200 when the variation of the measurement value in the predetermined period after second time t2 is equal to or larger than the predetermined second management value. For example, the second management value is a value larger than first management value V1. The predetermined period is desirably the same period as the periods of first time t1 and second time t2, but is not limited thereto, and may be a period shorter than the periods of first time t1 and second time t2.

As illustrated in FIG. 8, sensor 200b measures the state quantity of space 10 at a predetermined sampling period while moving even after second time t2. Sensor mobile body 250b stops the movement when the variation of the measurement value of sensor 200b is equal to or larger than the second management value. As a result, the position of sensor 200b is fixed.

Sensor mobile body 250b transmits the measurement value of sensor 200b whose position is fixed to spatial-state prediction device 500. Spatial-state prediction device 500 performs data assimilation processing using the measurement value of sensor 200b whose position is newly fixed and the measurement values of sensors 200a and 200c whose positions are already fixed.

As described above, spatial-state prediction system 1A includes information acquisition unit 220 that acquires the measurement value of sensor 200 arranged at the predetermined position in space 10, and controller 230 that outputs the movement signal for moving sensor 200 when the variation of the measurement value of sensor 200 from first time t1 to second time t2 is equal to or less than first management value V1.

According to this configuration, sensor 200 that has not been able to grasp the change in the state of space 10 can be moved to a position where the change in the state of space 10 can be grasped. As a result, it is possible to suppress a decrease in the prediction accuracy of the state of space 10.

Note that the example in which one sensor 200 among the plurality of sensors 200 is moved has been described above, but the number of sensors 200 to be moved is not limited to one. For example, when there are two or more sensors 200 having a large variation of the measurement value, each sensor mobile body 250 on which each sensor 200 is mounted may move simultaneously.

Although the example in which sensor mobile body 250 determines whether to move sensor 200 has been described above, the present disclosure is not limited thereto. For example, sensor mobile body 250 may transmit a measurement value of sensor 200 to spatial-state prediction device 500, and spatial-state prediction device 500 may determine whether to move sensor mobile body 250. That is, spatial-state prediction device 500 may have the functions of information acquisition unit 220 and controller 230 described above.

### [Spatial-State Prediction Method According to Example]

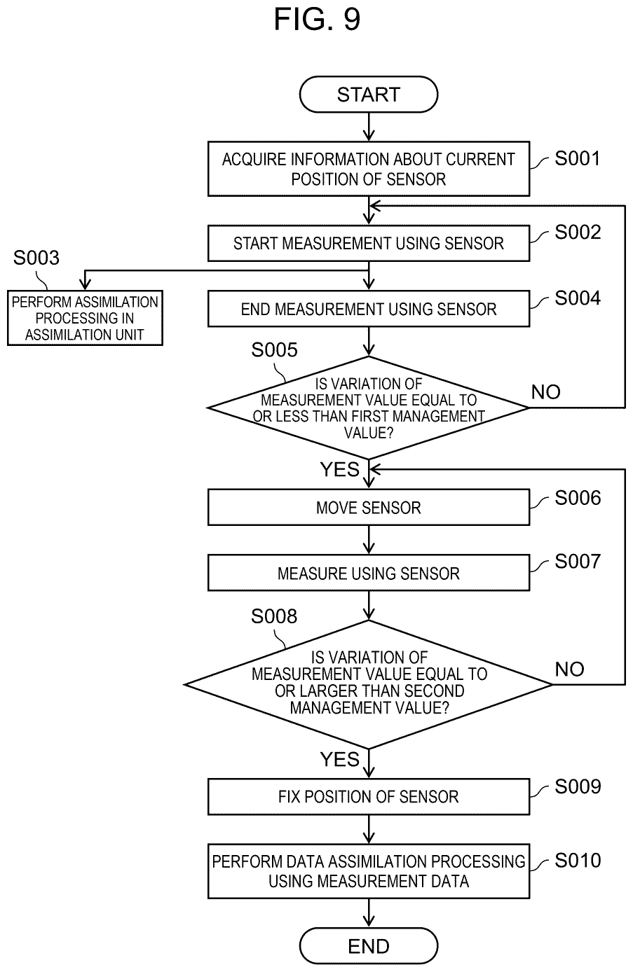

A spatial-state prediction method according to an example will be described with reference to FIG. 9.

FIG. 9 is a flowchart illustrating a spatial-state prediction method according to the example.

Spatial-state prediction system 1A acquires information regarding the current position of sensor 200 (step S001). At this point, the position of sensor 200 is fixed.

Next, spatial-state prediction system 1A starts measurement using sensor 200 (step S002). The measurement using sensor 200 is measurement of a state quantity of space 10. The time when the measurement is started in this step is first time t1. Sensor 200 continues measurement at a predetermined sampling period.

The measurement data obtained by sensor 200 is transmitted to assimilation unit 510 of spatial-state prediction device 500 via network 2. Assimilation unit 510 performs data assimilation processing based on the measurement data (step S003).

Next, spatial-state prediction system 1A temporarily ends the measurement using sensor 200 (step S004). The time when the measurement is ended in this step is second time t2. The period from first time t1 to second time t2 is a period appropriately selected from a range of, for example, 10 minutes or more and 50 minutes or less.

Spatial-state prediction system 1A determines whether it is necessary to move sensor 200 arranged in space 10. Spatial-state prediction system 1A according to the present example determines whether the movement of sensor 200 is necessary depending on whether the variation of the measurement value of sensor 200 from first time t1 to second time t2 is equal to or less than predetermined first management value V1 (step S005).

When the variation of the measurement value is not equal to or less than first management value V1 (No in S005), spatial-state prediction system 1A maintains the current position of sensor 200 and returns to step S002.

When the variation of the measurement value is equal to or less than first management value V1 (Yes in S005), spatial-state prediction system 1A moves sensor 200 (step S006). Specifically, spatial-state prediction system 1A moves sensor 200 by driving mobile device 210 of sensor mobile body 250.

Spatial-state prediction system 1A measures the state quantity of space 10 using sensor 200 even while sensor 200 is moving (step S007). Step S007 may be executed simultaneously with step S006, or may be executed after the movement in step S006 is completed.

After moving sensor 200 in step S006, spatial-state prediction system 1A fixes sensor 200 at an appropriate position.

For example, spatial-state prediction system 1A determines whether the variation of the measurement value of sensor 200 in the predetermined period is equal to or larger than the second management value (step S008). For example, the second management value is a value larger than first management value V1. The predetermined period is desirably the same period as the periods of first time t1 and second time t2, but is not limited thereto, and may be a period shorter than the periods of first time t1 and second time t2.

When the variation of the measurement value is not equal to or larger than the second management value (No in S008), spatial-state prediction system 1A returns to step S006 and continues or restarts the movement of sensor 200. On the other hand, when the variation of the measurement value is equal to or larger than the second management value (Yes in S008), spatial-state prediction system 1A stops the movement of sensor 200 and fixes the position of sensor 200 (step S009).

Spatial-state prediction system 1A performs data assimilation processing using the measurement data of sensor 200 whose position is fixed (step S010). By repeating these steps S001 to S010, the spatial-state prediction method according to the example is executed.

As described above, the spatial-state prediction method includes a step of acquiring a measurement value of sensor 200 arranged at a predetermined position in space 10, and a step of moving sensor 200 when a variation of the measurement value of sensor 200 from first time t1 to second time t2 is equal to or less than first management value V1. According to this method, sensor 200 that has not been able to grasp the change in the state of space 10 can be moved to a position where the change in the state of space 10 can be grasped. As a result, it is possible to suppress a decrease in the prediction accuracy of the state of space 10.

### Modification 1

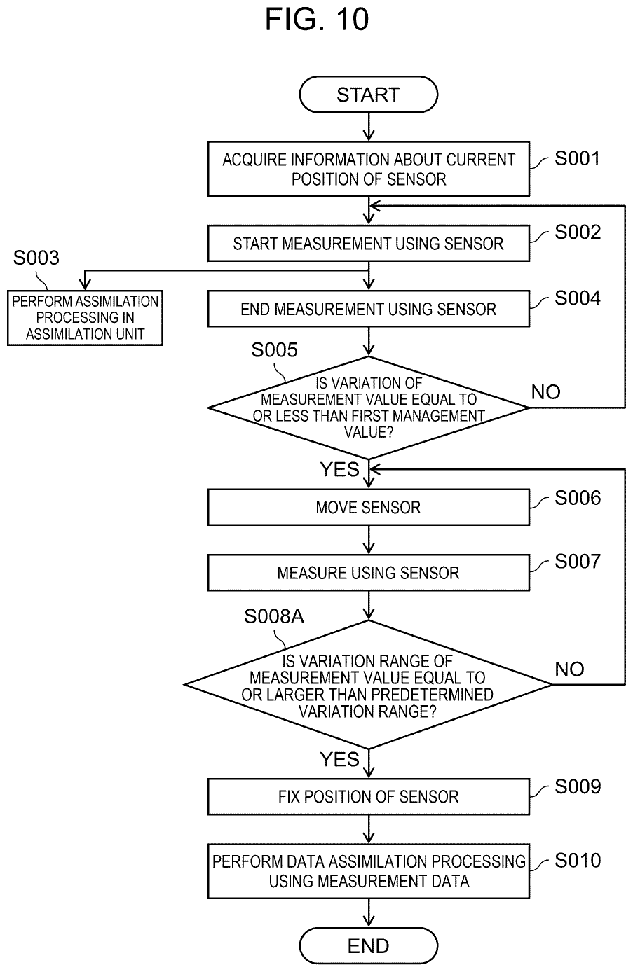

A spatial-state prediction method of Modification 1 will be described with reference to FIG. 10. In Modification 1, an example in which the movement of sensor 200 is stopped when the variation range of the measurement value of sensor 200 when sensor 200 is moved becomes larger than a predetermined variation range will be described.

FIG. 10 is a flowchart illustrating a spatial-state prediction method of Modification 1. Steps S001 to S007 are the same as those in the example.

In Modification 1, in step S007, the state quantity of space 10 is measured while moving sensor 200. Spatial-state prediction system 1A of Modification 1 determines whether a variation range of a measurement value of sensor 200 in a predetermined period when sensor 200 is moved is equal to or larger than a predetermined variation range (step S008A). The predetermined period may start immediately after second time t2 or may start slightly after second time t2. That is, the predetermined period may be any period starting from the sampling period after second time t2. Furthermore, spatial-state prediction system 1A may obtain a variation range of the front-rear section while taking a moving average in a predetermined period, and determine whether the variation range is equal to or larger than a predetermined variation range.

When the variation range of the measurement value is not equal to or larger than the predetermined variation range (No in S008A), spatial-state prediction system 1A returns to step S006 and continues the movement of sensor 200. On the other hand, when the variation range of the measurement value is equal to or larger than the predetermined variation range (Yes in S008A), spatial-state prediction system 1A stops the movement of sensor 200 and fixes the position of sensor 200 (step S009). Step S010 and the subsequent steps are the same as those in the example.

### Modification 2

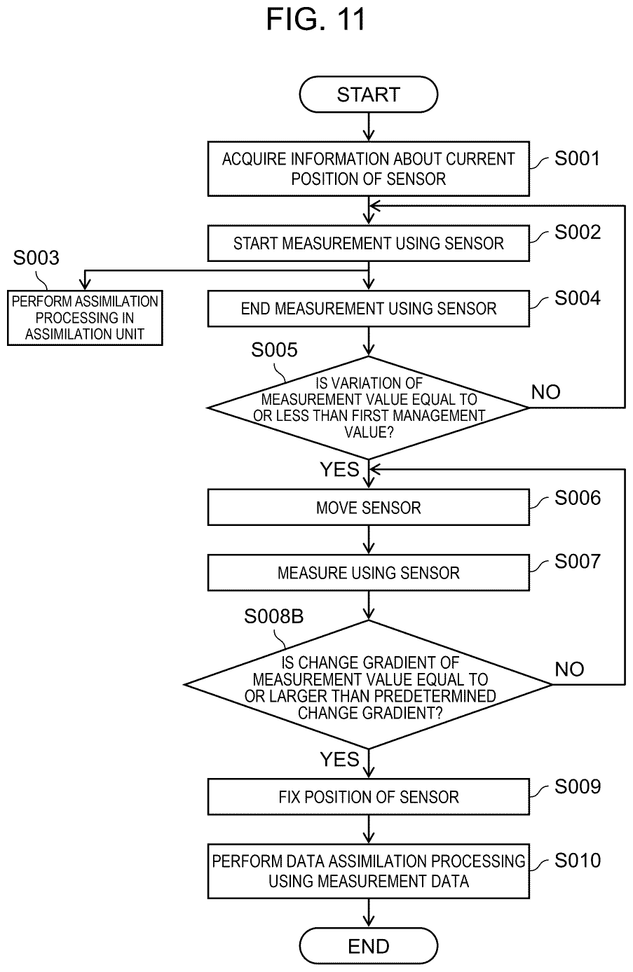

A spatial-state prediction method of Modification 2 will be described with reference to FIG. 11. In Modification 2, an example in which the movement of sensor 200 is stopped when the change gradient of the measurement value of sensor 200 when sensor 200 is moved becomes larger than a predetermined change gradient will be described.

FIG. 11 is a flowchart illustrating a spatial-state prediction method of Modification 2. Steps S001 to S007 are the same as those in the example.

In Modification 2, in step S007, the state quantity of space 10 is measured while moving sensor 200. Spatial-state prediction system 1A of Modification 2 determines whether a change gradient of a measurement value of sensor 200 in a predetermined period when sensor 200 is moved is equal to or larger than a predetermined change gradient (step S008B). The predetermined period may start immediately after second time t2 or may start slightly after second time t2. That is, the predetermined period may be any period starting from the sampling period after second time t2.

When the change gradient of the measurement value is not equal to or larger than the predetermined change gradient (No in S008B), spatial-state prediction system 1A returns to step S006 and continues the movement of sensor 200. On the other hand, when the change gradient of the measurement value is equal to or larger than the predetermined change gradient (Yes in S008B), spatial-state prediction system 1A stops the movement of sensor 200 and fixes the position of sensor 200 (step S009). Step S010 and the subsequent steps are the same as those in the example.

### Modification 3

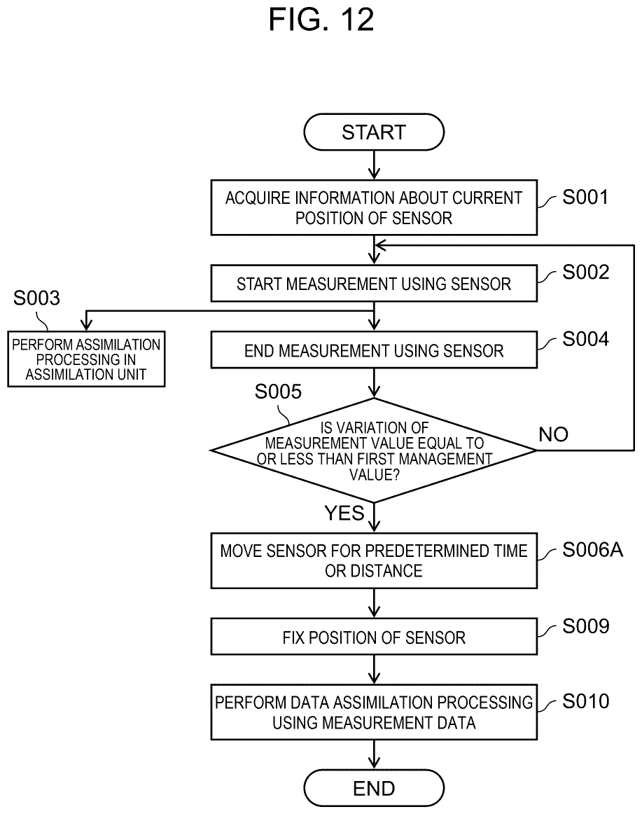

A spatial-state prediction method of Modification 3 will be described with reference to FIG. 12. In Modification 3, an example in which sensor 200 is moved by a preset time or distance will be described.

FIG. 12 is a flowchart illustrating a spatial-state prediction method of Modification 3. Steps S001 to S005 are the same as those in the example.

In Modification 3, in step S006A, sensor 200 is moved by a preset time or distance. The preset time is, for example, 1/10 of the sampling period. The preset distance is, for example, a distance of 1/10 of the vertical or horizontal length of space 10. The preset distance may be a distance for one cell of the mesh formed in space 10 to perform the simulation analysis.

After moving sensor 200 in step S006A, spatial-state prediction system 1A fixes the position of sensor 200 (step S009). Step S010 and the subsequent steps are the same as those in the example.

### Conclusion

A spatial-state prediction method and the like according to an aspect of the present disclosure will be exemplified.

A spatial-state prediction method of Example 1 is a method for predicting a state quantity in space 10 by performing data assimilation processing using a measurement value of sensor 200 that detects a state quantity in space 10, and includes: a step of acquiring a measurement value of sensor 200 arranged at a predetermined position in space 10; and a step of moving sensor 200 when a variation of the measurement value of sensor 200 from first time t1 to second time t2 is equal to or less than predetermined first management value V1.

As described above, by moving sensor 200 when the variation of the measurement value of sensor 200 is equal to or less than predetermined first management value V1, sensor 200 that has not grasped the change in the state of space 10 can be moved to a position where the change in the state of space 10 can be grasped. As a result, it is possible to suppress a decrease in the prediction accuracy of the state of space 10.

A spatial-state prediction method of Example 2 is the spatial-state prediction method described in Example 1, and in the step of moving sensor 200, sensor 200 may be moved when the difference between the maximum value and the minimum value of the measurement value is equal to or less than first management value V1.

As described above, by moving sensor 200 when the difference between the maximum value and the minimum value of the measurement value is equal to or less than first management value V1, sensor 200 that has not grasped the change in the state of space 10 can be moved to a position where the change in the state of space 10 can be grasped. As a result, it is possible to suppress a decrease in the prediction accuracy of the state of space 10.

A spatial-state prediction method of Example 3 is the spatial-state prediction method described in Example 1, and in the step of moving sensor 200, sensor 200 may be moved when the change gradient of the measurement value from first time t1 to second time t2 is equal to or less than first management value V1.

As described above, by moving sensor 200 when the change gradient of the measurement value is equal to or less than first management value V1, sensor 200 that has not grasped the change in the state of space 10 can be moved to a position where the change in the state of space 10 can be grasped. As a result, it is possible to suppress a decrease in the prediction accuracy of the state of space 10.

A spatial-state prediction method of Example 4 is the spatial-state prediction method according to any of Examples 1 to 3, and may further include: a step of fixing the position of sensor 200 after moving sensor 200; and a step of performing data assimilation processing by using a measurement value of sensor 200 whose position is fixed.

According to this, the data assimilation processing can be performed using the measurement value of sensor 200 after sensor 200 is moved. As a result, it is possible to suppress a decrease in the prediction accuracy of the state of space 10.

A spatial-state prediction method of Example 5 is the spatial-state prediction method described in Example 4, and in the step of fixing the position of sensor 200, the position of sensor 200 may be fixed when the variation of the measurement value of sensor 200 in the predetermined period is equal to or larger than the predetermined second management value.

As described above, by fixing the position of sensor 200 when the variation of the measurement value is equal to or larger than the predetermined second management value, it is possible to appropriately capture the change in the state of space 10. As a result, it is possible to suppress a decrease in the prediction accuracy of the state of space 10.

A spatial-state prediction method of Example 6 is the spatial-state prediction method described in Example 5, in which the second management value may be a value greater than first management value V1.

According to this configuration, sensor 200 can be fixed at a position where a change in the state of space 10 can be largely captured. As a result, it is possible to suppress a decrease in the prediction accuracy of the state of space 10.

A spatial-state prediction method of Example 7 is the spatial-state prediction method described in Example 4, and in the step of fixing the position of sensor 200, the position of sensor 200 may be fixed when a variation range of the measurement value in a predetermined period when sensor 200 is moved in the step of moving sensor 200 becomes larger than a predetermined variation range.

As described above, by fixing the position of sensor 200 when the variation range of the measurement value becomes larger than the predetermined variation range, it is possible to appropriately capture the change in the state of space 10. As a result, it is possible to suppress a decrease in the prediction accuracy of the state of space 10.

A spatial-state prediction method of Example 8 is the spatial-state prediction method described in Example 4, and in the step of fixing the position of sensor 200, the position of sensor 200 may be fixed when a change gradient of the measurement value in a predetermined period when sensor 200 is moved in the step of moving sensor 200 becomes larger than a predetermined change gradient.

As described above, by fixing the position of sensor 200 when the change gradient of the measurement value becomes larger than the predetermined change gradient, it is possible to appropriately capture the change in the state of space 10. As a result, it is possible to suppress a decrease in the prediction accuracy of the state of space 10.

A spatial-state prediction method of Example 9 is the spatial-state prediction method described in Example 4, where sensor 200 may be moved by a predetermined time or distance in the step of moving sensor 200.

According to this, the arrangement position of sensor 200 can be easily determined.

A spatial-state prediction method of Example 10 is the spatial-state prediction method according to any one of Examples 1 to 9, in which the period from first time t1 to second time t2 may be a period of 10 minutes or more and 50 minutes or less.

According to this configuration, it is possible to determine whether a change in the state of space 10 has been able to be captured with an appropriate measurement time. As a result, it is possible to suppress a decrease in the prediction accuracy of the state of space 10.

A spatial-state prediction method of Example 11 is the spatial-state prediction method of any of Examples 1 to 9, in which sensor 200 may measure a temperature, a flow rate, or a gas concentration in space 10.

According to this, it is possible to suppress a decrease in the prediction accuracy of the temperature, the flow rate, or the gas concentration which is the state quantity of space 10.

Spatial-state prediction system 1A of Example 12 is spatial-state prediction system 1A that performs data assimilation processing using a measurement value of sensor 200 that detects a state quantity in space 10 and predicts the state quantity in space 10, and includes information acquisition unit 220 that acquires a measurement value of sensor 200 arranged at a predetermined position in space 10, and controller 230 that outputs a movement signal for mobile sensor 200 when a variation of the measurement value of sensor 200 from first time t1 to second time t2 is equal to or less than predetermined first management value V1.

According to this configuration, sensor 200 that has not been able to grasp the change in the state of space 10 can be moved to a position where the change in the state of space 10 can be grasped. As a result, it is possible to suppress a decrease in the prediction accuracy of the state of space 10.

### Other Exemplary Embodiments

Although the spatial-state prediction method and the like in the present disclosure have been described above based on the exemplary embodiments, the present disclosure is not limited to the exemplary embodiments. The exemplary embodiment to which various modifications conceivable by those skilled in the art are applied, or another form constructed by combining some constituent elements in the exemplary embodiment is also included in the scope of the present disclosure without departing from the gist of the present disclosure.

### INDUSTRIAL APPLICABILITY

The spatial-state prediction method and the like of the present disclosure can be applied to an application of predicting a state quantity of a space such as a temperature of a space in a building.

### REFERENCE MARKS IN THE DRAWINGS

1, 1A: spatial-state prediction system
2: network
10: space
100: computer
101: input unit
102: arithmetic circuit
103: memory
104: output unit
105: storage
105a: program
105b: temporary data
106: communication unit
200: sensor
201: positioning sensor
210: mobile device
220: information acquisition unit
230: controller
240: drive mechanism
250: sensor mobile body
310: information terminal
320: external information source
500: spatial-state prediction device
510: assimilation unit
600: device
t1: first time
t2: second time
t3: third time
V1: first management value

1. A spatial-state prediction method for predicting a state quantity in a space by performing data assimilation processing using a measurement value of a sensor that detects the state quantity in the space, the spatial-state prediction method comprising:
a step of acquiring a measurement value of the sensor disposed at a predetermined position in the space; and
a step of moving the sensor when a variation of the measurement value of the sensor from a first time to a second time is equal to or less than a predetermined first management value.

2. The spatial-state prediction method according to claim 1, wherein
in the step of moving the sensor, when a difference between a maximum value and a minimum value of the measurement value is equal to or less than the first management value, the sensor is moved.

3. The spatial-state prediction method according to claim 1, wherein
in the step of moving the sensor, when a change gradient of the measurement value from the first time to the second time is equal to or less than the first management value, the sensor is moved.

4. The spatial-state prediction method according to claim 1, further comprising:
a step of fixing a position of the sensor after moving the sensor; and
a step of performing data assimilation processing using a measurement value of the sensor whose position is fixed.

5. The spatial-state prediction method according to claim 4, wherein
in the step of fixing the position of the sensor, the position of the sensor is fixed when a variation of the measurement value of the sensor in a predetermined period is equal to or larger than a predetermined second management value.

6. The spatial-state prediction method according to claim 5, wherein
the second management value is a value larger than the first management value.

7. The spatial-state prediction method according to claim 4, wherein
in the step of fixing the position of the sensor, the position of the sensor is fixed when a variation range of the measurement value in a predetermined period when the sensor is moved in the step of moving the sensor becomes larger than a predetermined variation range.

8. The spatial-state prediction method according to claim 4, wherein
in the step of fixing the position of the sensor, the position of the sensor is fixed when a change gradient of the measurement value in a predetermined period when the sensor is moved in the step of moving the sensor becomes larger than a predetermined change gradient.

9. The spatial-state prediction method according to claim 1, wherein
in the step of moving the sensor, the sensor is moved by a predetermined time or distance.

10. The spatial-state prediction method according to claim 1, wherein
a period from the first time to the second time is a period of 10 minutes or more and 50 minutes or less.

11. The spatial-state prediction method according to claim 1, wherein
the sensor measures a temperature, a flow rate, or a gas concentration in the space.

12. A spatial-state prediction system that performs data assimilation processing using a measurement value of a sensor that detects a state quantity in a space and predicts the state quantity in the space, the spatial-state prediction system comprising:
an information acquisition unit that acquires a measurement value of the sensor arranged at a predetermined position in the space; and
a controller that outputs a movement signal for moving the sensor when a variation of the measurement value of the sensor from a first time to a second time is equal to or less than a predetermined first management value.
